(19) United States
(12) Patent Application Publication
(10) Pub. No.: US 2024/0279967 A1
(43) Pub. Date: Aug. 22, 2024

(54) HANDLE MODULE, IN PARTICULAR EXTERIOR HANDLE MODULE

(71) Applicant: WITTE Automotive GmbH, Velbert (DE)

(72) Inventor: Reinaldo MENSCH, Wuppertal (DE)

(21) Appl. No.: 18/582,726

(22) Filed: Feb. 21, 2024

(30) Foreign Application Priority Data
Feb. 21, 2023 (DE) 10 2023 201 541.2

(51) Int. Cl. E05B 81/76

(52) U.S. Cl. CPC E05B 81/76; E05Y 2900/50

(57) ABSTRACT

A handle module may have a handle, a handle carrier with at least one bearing point for the movable mounting of the handle relative to the handle carrier and an electronic sensor unit which has at least one movable sensor element and a fixed sensor element, which is arranged opposite the movable sensor element. The movable sensor element may be arranged in the region of the bearing point between handle and handle carrier in such a way that, in the event of an actuating force acting on the handle, the movable sensor element is shiftable or movable relative to the fixed sensor element.

### BACKGROUND

The invention relates to a handle module, in particular for a handle, such as an exterior handle, for example for a movable vehicle element, such as a sliding door, a tailgate or an engine bonnet/front bonnet, of a vehicle.

### FIELD

Handle modules are known, for example, on vehicle doors, tailgates or engine bonnets. They are conventionally provided with a handle which can be pivoted or pulled outwards in order to be able to open the vehicle door, the tailgate or the engine bonnet. Handle modules may comprise electronic sensor modules for opening a lock of the door.

### SUMMARY

The invention is based on the object of specifying a handle module which is improved in comparison to the prior art and in which a handle can be actuated at any point.

The object according to the invention is achieved by the specified features of the claims described herein.

The object is achieved according to the invention by a handle module which comprises at least a handle, a handle carrier with at least one bearing point for the movable mounting of the handle relative to the handle carrier and an electronic sensor module or an electronic sensor unit which has at least one sensor unit with a movable sensor element and a fixed sensor element, which is arranged opposite the movable sensor element, wherein the movable sensor element is arranged in the region of the bearing point between handle and handle carrier in such a way that, in the event of an actuating force acting on the handle, the movable sensor element is shiftable or movable relative to the fixed sensor element.

Owing to the fact that the movable sensor element is arranged movably or shiftably in the region of a bearing point between handle and handle carrier, the handle can be actuated at any desired point in order to trigger a switching signal, for example, for an electronic lock, in particular a door lock. In addition, in the case of a handle module with two bearing points and two movable sensor surfaces, the force can be averaged, for example, by software of an electronic unit, in such a way that an almost constant actuating force is possible in all regions. When the handle is actuated, for example pulled or pivoted, the sensor elements, in particular metal surfaces or also called MoC (metal-over-cap) sheets, move away from each other, as a result of which the distance between them becomes greater. At least one of the sensor elements can be moved relative to the other sensor element, for example, under prestress or spring-assisted by means of a separate spring element.

For example, in the event of an actuating force acting on the handle, a distance and/or an angle between the movable sensor element and the fixed sensor element can change, and therefore a change in the measuring field is identifiable.

For example, the handle module can form a pull handle. The invention aims to position the movable sensor element, for example a sensor sheet or a sensor plate, at a bearing point and to detect a movement, in particular shifting and/or displacement, of the movable sensor element in this region. Alternatively or optionally additionally, the handle module can be actuated, for example pressed, counter to a pulling direction, for example.

For example, the handle can be pulled for unlocking and/or pressed for locking.

The electronic sensor module, referred to further on as electronic sensor unit, can be arranged at any point between the handle carrier and the handle. The invention makes it possible to avoid a specific deformation, known from the prior art, of a movable sensor element in the direction of a fixed sensor element for generating a sensor signal. The stability and design freedom of the handle module can thereby be increased.

In an unactuated position, the sensor elements of the electronic sensor unit may be arranged at a first distance from and/or first angle to each other.

In an actuated position, the sensor elements of the electronic sensor unit may be arranged at a second distance from and/or second angle to each other. The first distance and the second distance, or the first angle and the second angle, differ. A change in the measuring field can be detected in a simple manner.

The movable sensor element may be in the form of a spring sheet or a spring plate. The fixed sensor element may be formed by a part of a circuit board, for example a printed circuit board. The fixed sensor element may be a component which is formed from metal and which may be fastened to the printed circuit board.

The movable sensor element may be, for example, a triggering element. The movable sensor element may be fastened to one end of the printed circuit board and may be arranged spaced apart from the fixed sensor element. This makes a change in angle between the sensor elements possible.

The movable sensor element may be, for example, U-shaped. The movable sensor element may be fastened on the end side in each case to the printed circuit board and may be arranged spaced apart from the fixed sensor element. This enables displacement and a resulting change in distance between the sensor elements.

The fixed sensor element which is arranged on the printed circuit board may in each case form a fixed electrode. The movable sensor element may form a counter electrode which is movable with respect to the fixed electrode.

By actuation, for example pulling, of the handle away from the handle carrier, the movable sensor element may be moved or shifted with the movement of the handle such that a distance and/or an angle between the movable sensor element and the fixed sensor element can change, for example can increase or decrease. Alternatively or optionally additionally, by actuation, for example pressing, of the handle towards the handle carrier, the movable sensor element may be moved or shifted with the movement of the handle such that a distance and/or an angle between the movable sensor element and the fixed sensor element can change, for example can increase or decrease.

Optionally, by actuation, for example pulling, of the handle away from the handle carrier, the movable sensor element can be released in such a way that a distance and/or an angle between the movable sensor element and the fixed sensor element can increase. In a development, by actuation, for example pressing, of the handle towards the handle carrier, the movable sensor element can be released in such a way that a distance and/or an angle between the movable sensor element and the fixed sensor element can increase.

Optionally, by actuation, for example pulling, of the handle away from the handle carrier, a force may be applied to the movable sensor element in the direction of the fixed sensor element such that a distance and/or an angle between the movable sensor element and the fixed sensor element can be reduced. In a development, by actuation, for example pressing, of the handle towards the handle carrier, a force may be applied to the movable sensor element in the direction of the fixed sensor element such that a distance and/or an angle between the movable sensor element and the fixed sensor element can be reduced.

A movement of the movable sensor element may occur in a manner of a displacement relative to the fixed sensor element. The movable sensor element may be positioned at the bearing point in such a way that a displacement of the movable sensor element can be detected in this region.

In a development, the movement of the movable sensor element may occur in the form of bending relative to the fixed sensor element. The movable sensor element may be positioned at the bearing point in such a way that bending of the movable sensor element can be detected in this region.

A movement of the movable sensor element may occur, for example, in a micrometre range.

A resulting E-field change (change in an electric field) may be detected by the local change in distance and/or change in angle and inferred upon an actuation request.

Owing to the fact that the electronic sensor unit is arranged in the region of a bearing point of the handle carrier for mounting the handle on the handle carrier, a sensor signal can be generated, even if the handle is pulled at different points.

In an unactuated position, the movable sensor element may be prestressed, in particular held under prestress. The movable sensor element is prestressed in the direction of the fixed sensor element. In other words, the movable sensor element may be held under prestress in the direction of the fixed sensor element. In an actuated position, the movable sensor element may be so relaxable in such a way that it moves away at least in some sections from the fixed sensor element.

In an unactuated position, for example also in an installation position, the movable sensor element and the fixed sensor element may be aligned parallel to the handle in the region of the bearing point. In an unactuated position, for example also in an installation position, the movable sensor element and the fixed sensor element may be aligned perpendicular to the handle in the region of the bearing point.

At least one electronic sensor unit may be arranged in each case, for example, in a rear and/or front region of the handle, for example a handle arm and/or handle extension arm. At least one electronic sensor unit may be arranged in the handle carrier. Owing to the fact that at least one electronic sensor unit is arranged in the region of a bearing point, the sensitivity of the sensor unit may be very substantially constant throughout the region of engagement.

The handle carrier and/or the at least one bearing point may comprise at least one bearing arm which protrudes from a base and on which the handle is held so as to be movably guided. One of the sensor elements may be connected to a free end of the bearing arm. For example, the movable sensor element may be assigned to the bearing arm. Another of the sensor elements may be connected to the handle. For example, the fixed sensor element may be assigned to the handle. During a movement of the handle relative to the bearing arm, a distance and/or an angle between the sensor elements may be changeable. By actuation, for example pulling, of the handle away from the handle carrier, the fixed sensor element may be moved with the handle, in particular may be moved parallel to the handle, as a result of which the sensor elements move away from each other. The movable sensor element may be bent or displaced relative to the fixed sensor element. When the handle is actuated away from the bearing arm, a distance and/or an angle between the sensor elements increases.

By actuation, for example pressing, of the handle towards the handle carrier, the fixed sensor element may be moved with the handle, in particular may be moved parallel to the handle, as a result of which the sensor elements move closer to each other. The movable sensor element may be bent or displaced relative to the fixed sensor element. For example, when the handle is actuated towards the bearing arm, a distance and/or an angle between the sensor elements decreases.

At least one bearing point may comprise at least one carry-along element, which is pivotably mounted for a movement of the handle about a pivot point and has a contact surface, which is operatively connected to the movable sensor element and, when the handle is actuated away from the handle carrier, releases the movable sensor element to move away from the fixed sensor element or applies a force to move same towards the fixed sensor element. The carry-along element may be held under prestress in the direction of the movable sensor element.

At least one bearing point may comprise a lever mechanism, in particular handle extension mechanism, with a lever, which is pivotably mounted for a movement of the handle about a pivot point and comprises a driver which, when the handle is actuated away from the handle carrier, carries along the movable sensor element and moves or shifts same away from the fixed sensor element.

The features disclosed in the above description, the claims and the drawings may be of significance for the implementation of the invention in its various embodiments, both individually and in combination.

### DESCRIPTION OF THE FIGURES

Exemplary embodiments of the invention will be explained in more detail with reference to drawings. In the drawings:

FIG. 1 shows schematically, in a sectional illustration, a first exemplary embodiment of a handle module in an unactuated position,

FIG. 2 shows schematically, in a sectional illustration, the first exemplary embodiment of the handle module in an actuated position,

FIG. 3 shows schematically, in a sectional illustration, a second exemplary embodiment of a handle module in an unactuated position,

FIG. 4 shows schematically, in a sectional illustration, the second exemplary embodiment of the handle module in an actuated position,

FIG. 5 shows schematically, in a sectional illustration, a third exemplary embodiment of a handle module in a retracted handle position,

FIG. 6 shows schematically, in a sectional illustration, the third exemplary embodiment of the handle module in an extended handle position,

FIG. 7 shows schematically, in a sectional illustration, the third exemplary embodiment of the handle module in an actuated position,

FIG. 8 shows schematically, in a sectional illustration, a fourth exemplary embodiment of a handle module in an unactuated position,

FIG. 9 shows schematically, in a sectional illustration, the fourth exemplary embodiment of the handle module in an actuated position,

FIG. 10 shows schematically, in a sectional illustration, a fifth exemplary embodiment of a handle module in an unactuated position,

FIG. 11 shows schematically, in a sectional illustration, the fifth exemplary embodiment of the handle module in an actuated position,

FIG. 12 shows schematically, in a sectional illustration, a sixth exemplary embodiment of a handle module in an unactuated position, and

FIG. 13 shows schematically, in a sectional illustration, the sixth exemplary embodiment of the handle module in an actuated position.

### DETAILED DESCRIPTION

Mutually corresponding parts are provided with the same reference signs in all of the figures.

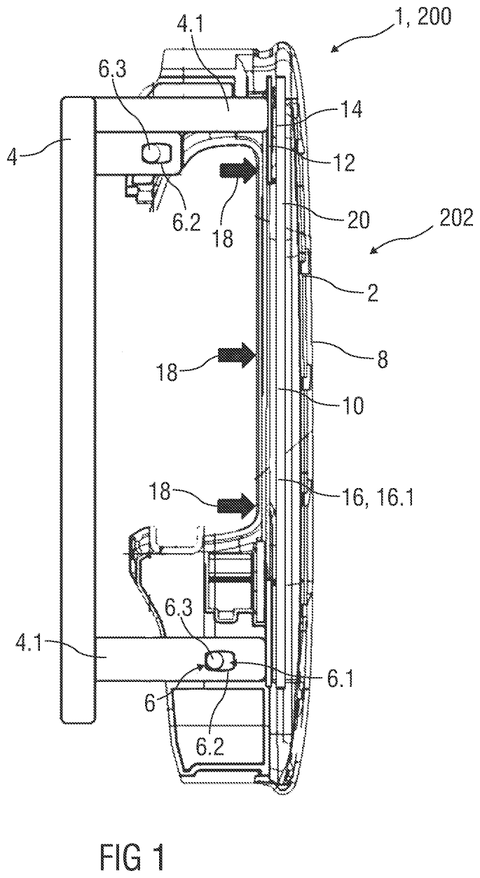

FIG. 1 shows schematically, in a sectional illustration, a first exemplary embodiment of a handle module 1 (hereinafter referred to as first handle module 1) in an unactuated position 200.

The first handle module 1 may be in the form of an exterior handle module, in particular a door exterior handle module. The first handle module 1 may comprise a handle 2. The first handle module 1 may comprise a handle carrier 4. The handle carrier 4 comprises at least one bearing point 6 for the movable mounting of the handle 2 relative to the handle carrier 4.

In addition, the handle 2 may be outwardly covered by means of a handle cover 8, for example a chrome cover or plastics cover.

The first handle module 1 may comprise a sensor unit 10. The sensor unit 10 may be in the form of an electronic sensor unit 10. The sensor unit 10 comprises, for example, a movable sensor element 12 and a fixed sensor element 14, which is arranged opposite the movable sensor element 12. The sensor unit 10 may also comprise an electronic unit 16.

The movable sensor element 12 is arranged in the region of the bearing point 6 between handle 2 and handle carrier 4 in such a way that, in the event of an actuating force 18 acting on the handle 2, the movable sensor element 12 is shiftable or movable relative to the fixed sensor element 14.

The electronic unit 16 may be arranged in a receptacle 20 of the handle 2. The electronic unit 16 may, for example, be insertable or pushable into the receptacle 20 and cast and/or held there, for example, in a form-fitting and/or force-fitting and/or integrally bonded manner, for example by means of a frictional connection, or by latching or overmoulding.

In addition, by the formation of the first handle module 1 with the inner electronic sensor unit 10, an electric door lock can be reliably triggered by generating a switching signal by means of the sensor unit 10, wherein the inner electronic components of the electronic sensor unit 10 are arranged protected. For this purpose, the electronic sensor unit 10 is protected, for example, by encapsulation, in particular additionally by means of a potting material, in the handle 2.

The electronic sensor unit 10 comprises the at least one electronic unit 16 and the fixed sensor element 14 and the movable sensor element 12.

The movable sensor element 12 is arranged spaced apart from and opposite the fixed sensor element 14. The electronic unit 16 is connected in terms of signalling to the sensor elements 12, 14 for triggering a switching signal for a door lock. For example, the electronic unit 16 comprises a printed circuit board 16.1 (also referred to as a carrier plate or circuit board). The fixed sensor element 14 is designed, for example, as a metal layer, in particular a copper layer, on the printed circuit board 16.1.

In addition, the movable sensor element 12 may be encapsulated at least in regions by means of a foam material (not illustrated specifically) and may be in the form of an integrated component with the fixed sensor element 14 and the printed circuit board 16.1. The sensor elements 12 and 14 may also be in the form of separate integrated components or in the form of a common integrated component.

The movable sensor element 12 and the fixed sensor element 14 are preferably arranged with respect to each other in such a way that, in the case of an actuating force 18 acting on the handle 2, in particular a pulling force, the handle 2 is movable, in particular pullable or pivotable, away from the handle carrier 4, as a result of which the movable sensor element 12 is shiftable or movable relative to the fixed sensor element 14 and the handle carrier 4. By the arrangement of the movable sensor element 12 and the fixed sensor element 14 in the region of the bearing point 6, the handle 2, for example for locking a lock, may also be actuable by a pressing movement in the direction of the handle carrier 4.

Owing to the fact that the movable sensor element 12 is arranged movably or shiftably in the region of the bearing point 6 between handle 2 and handle carrier 4, the handle 2 may be actuated at any desired point in order to trigger a switching signal, for example, for an electronic lock, in particular a door lock. By the formation of the first handle module 1 with two bearing points 6 and two movable sensor surfaces, the two movable sensor elements 12, the actuating force 18 can be averaged, for example, by software of an electronic unit 16, in such a way that an almost constant actuating force 18 can be achieved in all regions.

The handle carrier 4 is arranged in particular in a positionally fixed manner and, for example, is arranged or fastened on a tailgate, a vehicle door or an engine bonnet.

According to a first embodiment, the bearing point 6 may be in the form of a linear guide 6.1 and/or a rotary joint 6.2. The linear guide 6.1 may be, for example, in the form of a pin-slot guide. The rotary joint 6.2 may comprise a pin 6.3 or stud, which is rotatably mounted. The pin 6.3 or stud may, for example, be arranged rotatably in a short, slot-shaped guide, in particular the linear guide 6.1.

According to the first embodiment, the first handle module 1 comprises two bearing points 6, which are arranged spaced apart from each other. The handle carrier 4 is in the form, for example, of a handle bracket or a U-shaped bracket with two bearing arms 4.1 protruding perpendicularly from a base. The two bearing points 6 are formed in the region of the bearing arms 4.1.

The movable sensor element 12 is arranged in the region of the bearing point 6 between the handle carrier 4 and the handle 2. For example, the movable sensor element 12 may be arranged on the handle carrier 4, in particular at the free end of the bearing arm 4.1, opposite the handle 2. Alternatively, the movable sensor element 12 may be arranged on the handle 2 opposite the handle carrier 4, in particular at a free end of the bearing arm 4.1.

The sensor unit 10 may be in the form of a force sensor, in particular a force-controlled capacitive or inductive sensor, for carrying out a switching function, such as for example for unlocking a door lock and for opening a door. In particular, the sensor unit 10 is in the form of what is referred to as a MOC module (=metal-over-cap module), in which the interior metallic sensor elements 12, 14 can be encapsulated outwardly.

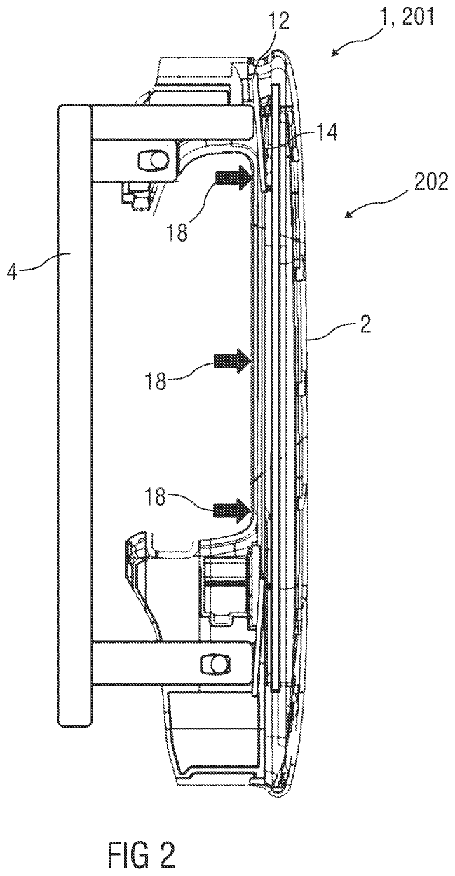

In the unactuated position 200 and/or in a retracted handle position 203, not illustrated specifically here, for example also in an installation position, the movable sensor element 12 and the fixed sensor element 14 may be aligned in the region of the bearing point 6 parallel to the handle 2, in particular to a handle outer surface. FIGS. 1 and 2 show the handle 2 already in an extended handle position 202 in both cases.

FIG. 2 shows schematically, in a sectional view, the first exemplary embodiment of the first handle module 1 in an actuated position 201.

When the handle 2 is actuated, for example pulled or pivoted, the sensor elements 12 and 14, in particular metal surfaces or also called MoC (metal-over-cap) sheets, move away from each other, as a result of which the distance between them becomes greater. For this purpose, the sensor element 12 is in the form of a movable sensor element 12. When the handle 2 is, for example, pressed or pivoted in the direction of a vehicle outer skin and/or in the direction of the handle carrier 4, the sensor elements 12 and 14 can move closer to each other, as a result of which the distance between them becomes smaller. Exemplary embodiments for actuating the handle 2 away from the handle carrier 4 are described below. It is clear that a respective actuation of the handle 2 in the direction of the handle carrier 4 may cause a corresponding opposed movement of the sensor elements 12 and 14.

In particular, the distance between the movable sensor element 12, for example a triggering element, and the fixed sensor element 14 is increased such that a measuring field present between them changes. For this purpose, the movable sensor element 12 is in the form, for example, of a lever-shaped spring plate or a lever-shaped spring sheet. Optionally, the distance between the movable sensor element 12 and the fixed sensor element 14 may decrease when the handle 2 is actuated.

The movable sensor element 12 may be in the form of an elastic triggering element. This permits in a simple manner a manually force-controlled switch with a reset function. In addition, the movable sensor element 12 may be switched as an electronic sensor element, in particular a capacitive sensor electrode.

The movable sensor element 12 may be moved relative to the other sensor element 14, for example, under prestress or spring-assisted by means of a separate spring element (not illustrated). For example, the movable sensor element 12 may be in the form of a spring sheet. For example, the spring sheet may be prestressed in the unactuated position 200. Upon actuation of the handle 2, in particular pulling of the handle 2 away from the handle carrier 4 at any desired point (indicated by the three actuating points of the actuating force 18), the spring sheet relaxes and moves away from the fixed sensor element 14 and away from the handle 2. In the example, the movable sensor element 12 is held in a positionally fixed manner at one end and the free end is shifted away, in particular pivoted up, from the fixed sensor element 14.

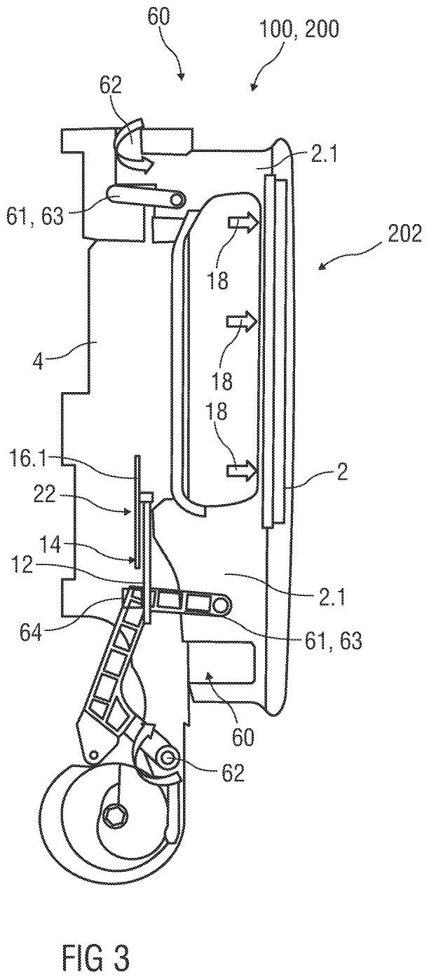

FIG. 3 shows schematically, in a sectional illustration, a second exemplary embodiment of a handle module 100 (hereinafter referred to as second handle module 100) in an unactuated position 200.

The second handle module 100 differs from the first handle module 1 according to FIGS. 1 and 2 in the type of bearing point 60 and the arrangement of the sensor unit 10. The sensor unit 10 is identical in function and design. Instead of a handle-side arrangement of the sensor unit 10, the latter is arranged on the handle carrier 4. The printed circuit board 16.1 with the fixed sensor element 14 is arranged and held in a carrier receptacle 22 of the handle carrier 4.

The fixed sensor element 14 is arranged opposite from a free end of a protruding handle arm 2.1 of the handle 2. Optionally, another pair of sensor elements 12, 14 may be arranged as triggering means (not shown specifically) on the other handle arm 2.1.

The respective bearing point 60 comprises a lever mechanism 61. The respective lever mechanism 61 comprises at least one lever 63, which is pivotably mounted about a pivot point 62. The lever 63 is coupled to the handle 2 on the one hand and coupled to the handle carrier 4 on the other hand. The lever 63 may comprise a carrier 64, which, for example, when the handle 2 is actuated away from the handle carrier 4, carries along the movable sensor element 12 and moves or shifts away from the fixed sensor element 14.

The second handle module 100 comprises only one pair of sensor elements 12, 14. The handle 2 may be actuated at any desired point and moved, in particular pivoted or pulled, away from the handle carrier 4 according to the actuating force 18 (arrow 18), in order to trigger a switching signal, for example, for an electronic lock, in particular a door lock.

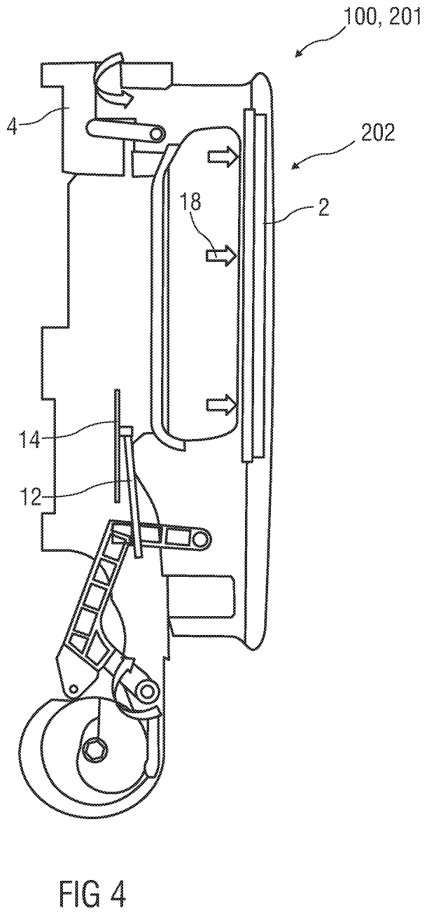

In the unactuated position 200 and/or in a retracted handle position 203, not illustrated specifically here, for example also in an installation position, the movable sensor element 12 and the fixed sensor element 14 may be aligned in the region of the bearing point 6 parallel to the handle 2, in particular to a handle outer surface. FIGS. 3 and 4 show the handle 2 already in an extended handle position 202 in both cases.

FIG. 4 shows schematically, in a sectional view, the second exemplary embodiment of the handle module 100 in the actuated position 201.

In analogy to the handle module 1 according to FIGS. 1 and 2, when the handle 2 is actuated, both the handle 2 and the movable sensor element 12 of the handle module 100 have moved away from the handle carrier 4 or from the fixed sensor element 14 as a result of the actuating force 18 (arrow 18). The movable sensor element 12 is designed identically, for example as a spring sheet, which is prestressed in the unactuated position 200 (FIG. 3) and relaxes in the actuated position 201.

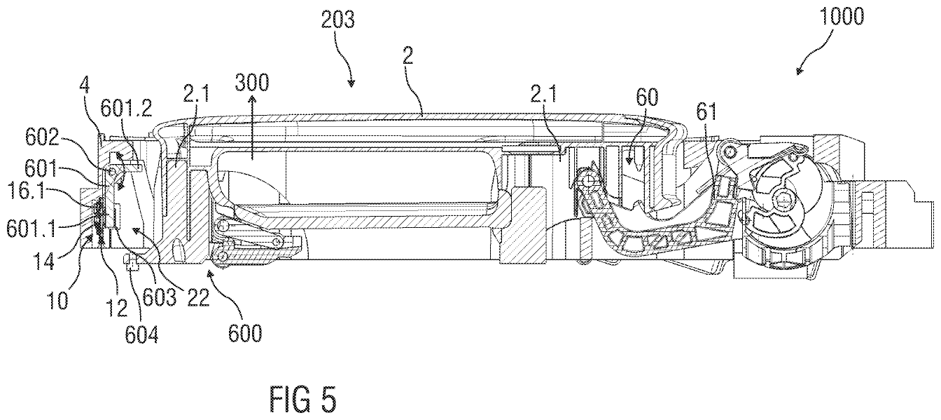

FIG. 5 shows schematically, in a sectional illustration, a third exemplary embodiment of a handle module 1000 in a retracted handle position 203.

The third handle module 1000 differs from the second handle module 100 according to FIGS. 3 and 4 in the manner of the arrangement and actuation of the sensor unit 10 and design of the associated bearing point 600. The sensor unit 10 is identical in function and design. The alignment of the sensor unit 10 differs. In the unactuated position 200 and/or the retracted handle position 203, the movable sensor element 12 and the fixed sensor element 14 are aligned perpendicular to the handle 2 in the region of the bearing point 600.

The sensor unit 10 is arranged on the handle carrier 4. The printed circuit board 16.1 with the fixed sensor element 14 is arranged and held in a carrier receptacle 22 of the handle carrier 4. The sensor unit 10 is arranged opposite the lever mechanism 61, which is provided for extending the handle 2. The handle module 1000 shown here can be arranged, for example, on the free handle arm 2.1. A further pair of sensor elements 12, 14, for example according to the second exemplary embodiment, may optionally be arranged as a triggering means (not illustrated specifically) on the other handle arm 2.1 and/or at the other bearing point 60.

The movable sensor element 12 is arranged on the printed circuit board 16.1. For example, the movable sensor element 12 may be in the form of a U-shaped sensor sheet. The movable sensor element 12 is fastened on the end side in each case to the printed circuit board 16.1 and arranged spaced apart from the fixed sensor element 14 or the printed circuit board 16.1.

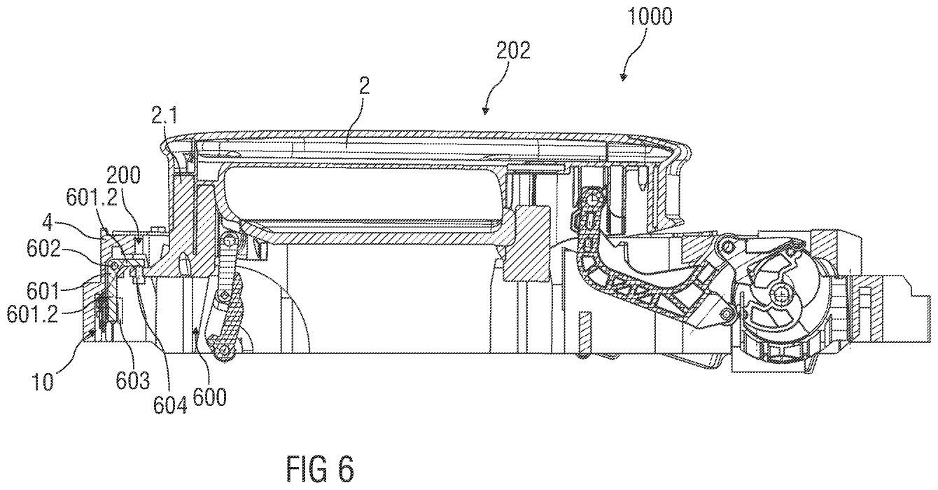

The at least one bearing point 600, in particular the handle carrier 4, comprises at least one carry-along element 601. The carry-along element 601 is in the form of an L-shaped lever. The carry-along element 601 is pivotably mounted for a movement of the handle 2 relative to the handle carrier 4 about a pivot point 602. The pivot point 602 is arranged, in particular fastened, in the carrier receptacle 22. The carry-along element 601 has a contact surface 601.1, which is operatively connected to the movable sensor element 12. The carry-along element 601 has a stop surface 601.2 which is connected to the contact surface 601.1 and, during a movement of the handle 2 away from the handle carrier 4 (in the extension direction 300), comes into contact with a driver 604 arranged on the handle 2. The driver 604 is arranged on an underside of the handle arm 2.1. The driver 604 may be in the form of a driver plunger. The carry-along element 601 is held prestressed in the direction of the sensor elements 12, 14. A spring force may be applied to the carry-along element 601, for example, by means of a spring element 603 arranged in the carrier receptacle 22. In the retracted handle position 203, the carry-along element 601 and the driver 604 are spaced apart from each other. When the handle 2 is extended into an extended handle position 202, as shown in FIG. 6, the driver 604 comes into contact with the carry-along element 601.

FIG. 6 shows schematically, in a sectional illustration, the third exemplary embodiment of the handle module 1000 in an extended handle position 202.

In the retracted handle position 203, the carry-along element 601 and the driver 604 are arranged spaced apart from each other. When the handle 2 is extended into the extended handle position 202, the driver 604 comes into contact with the carry-along element 601. In the extended handle position 202, the handle 2 may be actuated manually. If no manual actuation is performed, the driver 604 and carry-along element 601 may be held in the unactuated position 200. The movable sensor element 12 is prestressed in the unactuated position 200.

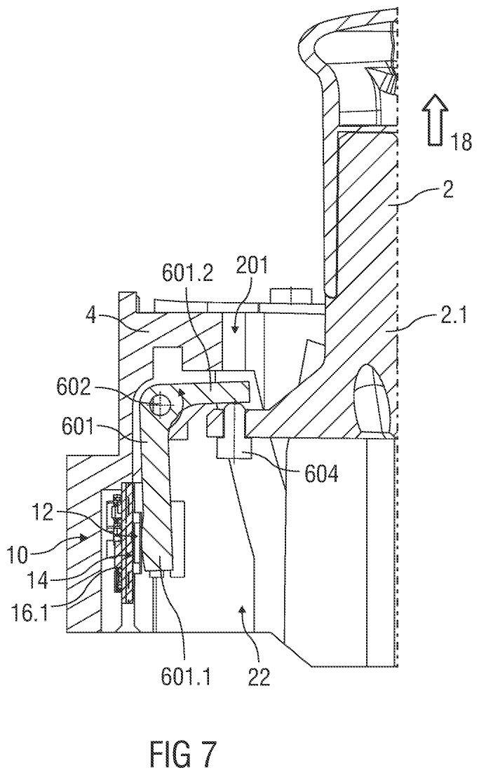

FIG. 7 shows schematically, in a sectional illustration, the third exemplary embodiment of the handle module 1000 in an actuated position 201.

In the event of an actuating force 18 acting on the handle 2, the movable sensor element 12 is released for movement away from the fixed sensor element 14. In this case, the driver 604 moves, in particular presses, the stop surface 601.2, with the carry-along element 601 being pivoted about the pivot point 602 and the contact surface 601.1 passing out of engagement or operative connection with the movable sensor element 12. In the actuated position 201, the movable sensor element 12 is released such that it can relax as much as possible and move away at least in some sections from the fixed sensor element 14. By actuation, for example pulling, of the handle 2 away from the handle carrier 4, the movable sensor element 12 is released in such a way that a distance and/or an angle between the movable sensor element 12 and the fixed sensor element 14 can increase. In particular, the distance between the movable sensor element 12, for example a triggering element, and the fixed sensor element 14 is increased such that a detectable measuring field present between them changes. A movement of the movable sensor element 12 may occur, for example, in a micrometre range.

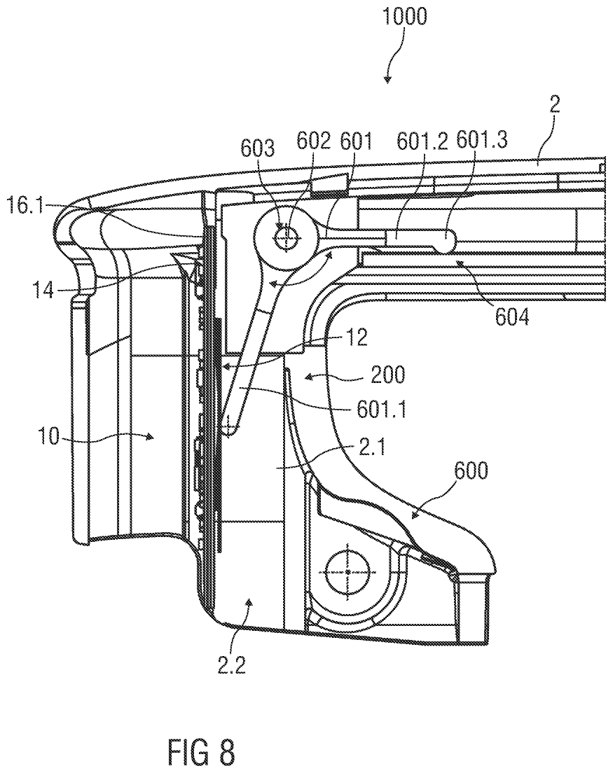

FIG. 8 shows schematically, in a sectional illustration, a fourth exemplary embodiment of a handle module 1000 in an unactuated position 200.

The fourth handle module 1000 differs from the third handle module 100 according to FIGS. 5 to 7 in the manner of the arrangement of the carry-along element 601 and the arrangement of the sensor unit 10. The sensor unit 10 is identical in function and design. The sensor unit 10 is arranged in one of the handle arms 2.1 of the handle 2. The printed circuit board 16.1 with the fixed sensor element 14 is arranged and held in a handle arm receptacle 2.2 of the handle 2. The sensor unit 10 is arranged opposite the lever mechanism 61, which is provided for extending the handle 2. The handle module 1000 shown here can be arranged, for example, on the free handle arm 2.1. A further pair of sensor elements 12, 14, for example according to the second exemplary embodiment, may optionally be arranged as a triggering means (not illustrated specifically) on the other handle arm 2.1 and/or at the other bearing point 60.

The movable sensor element 12 is arranged on the printed circuit board 16.1. For example, the movable sensor element 12 may be in the form of a U-shaped sensor sheet. For example, the movable sensor element 12 may be in the form of a spring sheet or spring leaf. The movable sensor element 12 is fastened on the end side in each case to the printed circuit board 16.1 and arranged spaced apart from the fixed sensor element 14 or the printed circuit board 16.1.

The at least one bearing point 600, in particular the handle carrier 4, comprises at least one carry-along element 601. The carry-along element 601 is in the form of an L-shaped lever. The carry-along element 601 may be arranged in an upper region of the handle arm 2.1. The carry-along element 601 may be arranged in some sections in a receptacle 20 of the handle 2.

The carry-along element 601 is pivotably mounted for a movement of the handle 2 relative to the handle carrier 4 about a pivot point 602. The carry-along element 601 may be arranged, for example, at one end of a bearing arm 4.1, not illustrated specifically here, of the handle carrier 4. The pivot point 602 may be arranged at the end of the bearing arm 4.1. The carry-along element 601 has a contact surface 601.1, which is operatively connected to the movable sensor element 12. The carry-along element 601 has a stop surface 601.2 which is connected to the contact surface 601.1 and, during a movement of the handle 2 away from the handle carrier 4, comes into contact with a driver 604 arranged on the handle 2. The driver 604 may be formed by an inner surface of the handle 2. Optionally, the driver 604 may be formed by a top side of the handle arm 2.1. The stop surface 601.2 may have a stop plunger 601.3. The carry-along element 601 is held prestressed in the direction of the sensor elements 12, 14. A spring force may be applied to the carry-along element 601, for example, by means of a spring element 603, not illustrated specifically, which is arranged on and/or at the pivot point 602. In a retracted handle position 203, not illustrated specifically, and in the unactuated position 200, the carry-along element 601 and the driver 604 may already be in contact. The stop surface 601.2 and/or the stop plunger 601.3 may rest on the driver 604 and/or on a carry-along surface formed in the handle 2. The movable sensor element 12 is prestressed in the unactuated position 200.

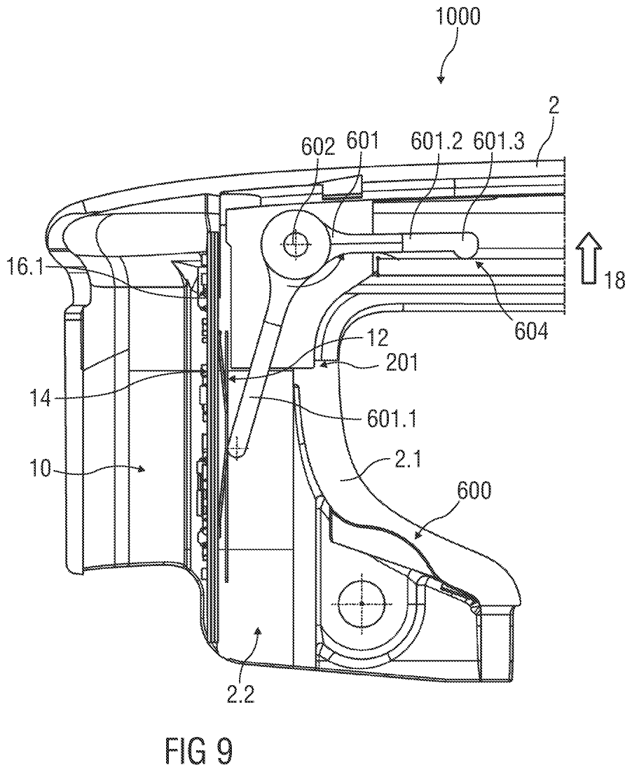

FIG. 9 shows schematically, in a sectional illustration, the fourth exemplary embodiment of the handle module 1000 in an actuated position 201.

In the event of an actuating force 18 acting on the handle 2, the movable sensor element 12 is released for movement away from the fixed sensor element 14. In this case, the driver 604 and/or the carry-along surface of the handle 2 moves, in particular presses, the stop surface 601.2 of the carry-along element 601, with the carry-along element 601 being pivoted about the pivot point 602 and the contact surface 601.1 passing out of engagement or operative connection with the movable sensor element 12. In the actuated position 201, the movable sensor element 12 is released such that it can relax as much as possible and move away at least in some sections from the fixed sensor element 14. By actuation, for example pulling, of the handle 2 away from the handle carrier 4, the movable sensor element 12 is released in such a way that a distance and/or an angle between the movable sensor element 12 and the fixed sensor element 14 can increase. In particular, the distance between the movable sensor element 12, for example a triggering element, and the fixed sensor element 14 is increased such that a detectable measuring field present between them changes. A movement of the movable sensor element 12 may occur, for example, in a micrometre range.

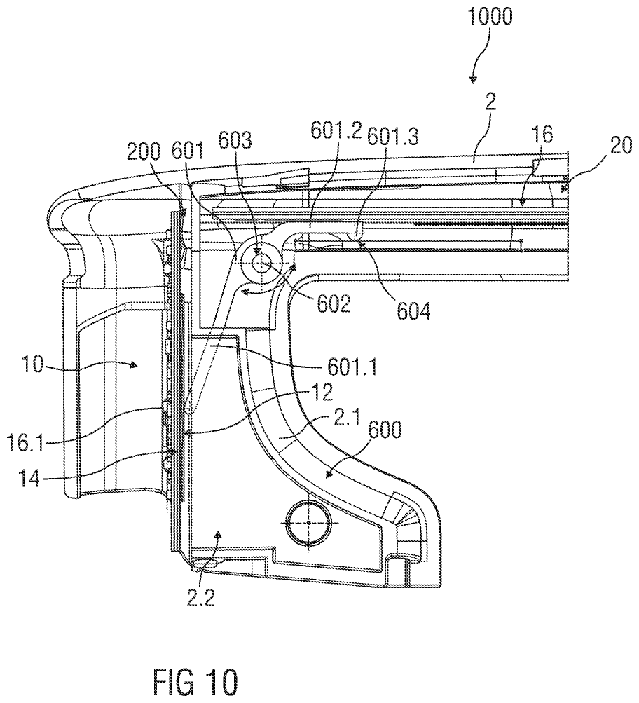

FIG. 10 shows schematically, in a sectional illustration, a fifth exemplary embodiment of a handle module 1000 in an unactuated position 200.

The fifth handle module 1000 differs from the fourth handle module 100 according to FIGS. 8 and 9 in the manner of the configuration of the carry-along element 601 and the arrangement of its pivot point 602. A further electronic unit 16 arranged in a receptacle 20 of the handle 2 may be provided. The electronic unit 16 may, for example, be insertable or pushable into the receptacle 20 and cast and/or held there, for example, in a form-fitting and/or force-fitting and/or integrally bonded manner, for example by means of a frictional connection, or by latching or overmoulding. The carry-along element 601 may be arranged in an upper region of the handle arm 2.1. The carry-along element 601 may be arranged in some sections in the receptacle 20 of the handle 2. In comparison to the fourth exemplary embodiment, the pivot point 602 may be placed deeper in the direction of the handle arm 2.1 of the handle 2, for example to ensure sufficient space for the electronic unit 16 in the receptacle 20 of the handle 2.

The sensor unit 10 is identical in function and design. The sensor unit 10 is arranged in one of the handle arms 2.1 of the handle 2. The printed circuit board 16.1 with the fixed sensor element 14 is arranged and held in a handle arm receptacle 2.2 of the handle 2. The sensor unit 10 is arranged opposite the lever mechanism 61, which is provided for extending the handle 2. The handle module 1000 shown here may be arranged, for example, on the free handle arm 2.1. A further pair of sensor elements 12, 14, for example according to the second exemplary embodiment, may optionally be arranged as a triggering means (not illustrated specifically) on the other handle arm 2.1 and/or at the other bearing point 60.

The movable sensor element 12 is arranged on the printed circuit board 16.1. For example, the movable sensor element 12 may be in the form of a U-shaped sensor sheet. For example, the movable sensor element 12 may be in the form of a spring sheet or spring leaf. The movable sensor element 12 is fastened on the end side in each case to the printed circuit board 16.1 and arranged spaced apart from the fixed sensor element 14 or the printed circuit board 16.1.

The at least one bearing point 600, in particular the handle carrier 4, comprises at least one carry-along element 601. The carry-along element 601 may be in the form of an L-shaped or J-shaped lever. The carry-along element 601 is pivotably mounted for a movement of the handle 2 relative to the handle carrier 4 about a pivot point 602. The carry-along element 601 may be arranged, for example, at one end of a bearing arm 4.1, not illustrated specifically here, of the handle carrier 4. The pivot point 602 may be arranged at the end of the bearing arm 4.1. The carry-along element 601 has a contact surface 601.1, which is operatively connected to the movable sensor element 12. The carry-along element 601 has a stop surface 601.2 which is connected to the contact surface 601.1 and, during a movement of the handle 2 away from the handle carrier 4, comes into contact with a driver 604 arranged on the handle 2. The driver 604 may be formed by an inner surface of the handle 2. Optionally, the driver 604 may be formed by a top side of the handle arm 2.1. The stop surface 601.2 may have a stop plunger 601.3. The carry-along element 601 is held prestressed in the direction of the sensor elements 12, 14. A spring force may be applied to the carry-along element 601, for example, by means of a spring element 603, not illustrated specifically, which is arranged on and/or at the pivot point 602. In a retracted handle position 203, not illustrated specifically, and in the unactuated position 200, the carry-along element 601 and the driver 604 may already be in contact. The stop surface 601.2 and/or the stop plunger 601.3 may rest on the driver 604 and/or on a carry-along surface formed in the handle 2. The movable sensor element 12 is prestressed in the unactuated position 200.

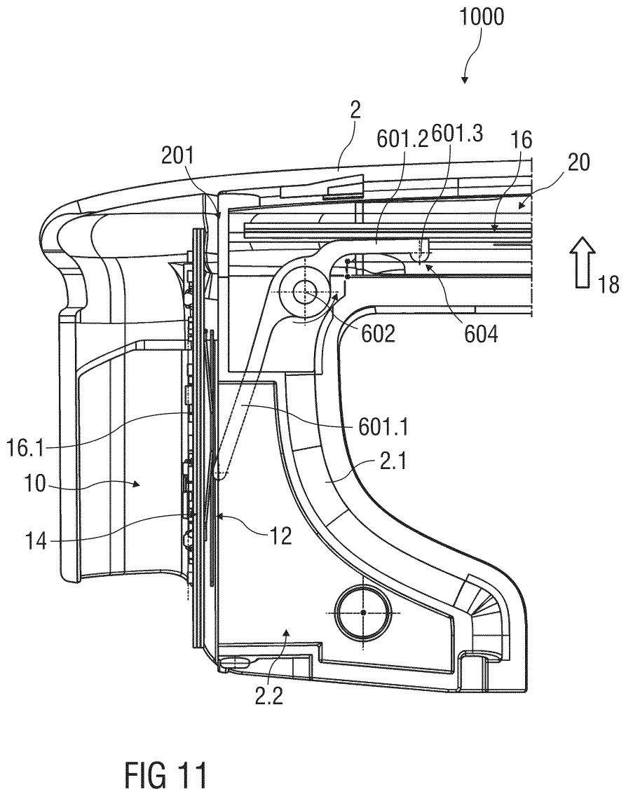

FIG. 11 shows schematically, in a sectional illustration, the fifth exemplary embodiment of the handle module 1000 in an actuated position 201.

In the event of an actuating force 18 acting on the handle 2, the movable sensor element 12 is released for movement away from the fixed sensor element 14. In this case, the driver 604 and/or the carry-along surface of the handle 2 moves, in particular presses, the stop surface 601.2 of the carry-along element 601, with the carry-along element 601 being pivoted about the pivot point 602 and the contact surface 601.1 passing out of engagement or operative connection with the movable sensor element 12. In the actuated position 201, the movable sensor element 12 is released such that it can relax as much as possible and move away at least in some sections from the fixed sensor element 14. By actuation, for example pulling, of the handle 2 away from the handle carrier 4, the movable sensor element 12 is released in such a way that a distance and/or an angle between the movable sensor element 12 and the fixed sensor element 14 can increase. In particular, the distance between the movable sensor element 12, for example a triggering element, and the fixed sensor element 14 is increased such that a detectable measuring field present between them changes. A movement of the movable sensor element 12 may occur, for example, in a micrometre range.

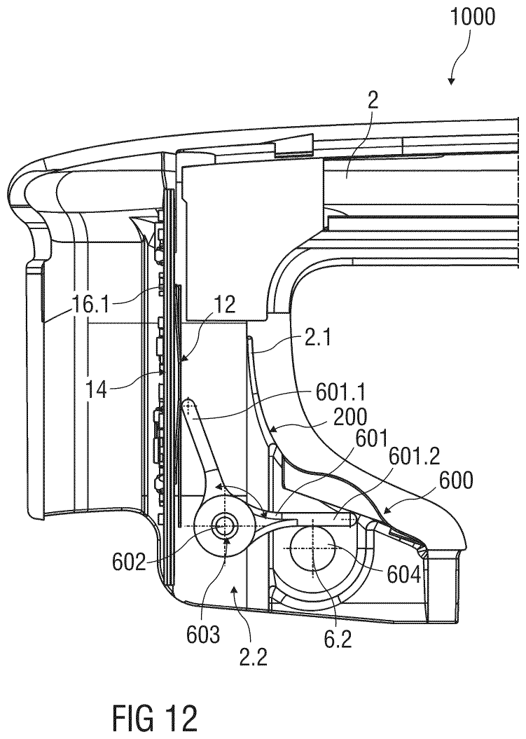

FIG. 12 shows schematically, in a sectional illustration, a sixth exemplary embodiment of a handle module 1000 in an unactuated position 200.

The sixth handle module 1000 differs from the fifth handle module 100 according to FIGS. 10 and 11 in the manner of the arrangement and actuation of the carry-along element 601 and the arrangement of its pivot point 602. The carry-along element 601 may be arranged in a lower region of the handle arm 2.1. The bearing point 600 may be in the form of a linear guide 6.1, not illustrated specifically, and/or a rotary joint 6.2, for example according to the exemplary embodiment according to FIGS. 1 and 2.

The sensor unit 10 is identical in function and design. The sensor unit 10 is arranged in one of the handle arms 2.1 of the handle 2. The printed circuit board 16.1 with the fixed sensor element 14 is arranged and held in a handle arm receptacle 2.2 of the handle 2. The sensor unit 10 is arranged opposite the lever mechanism 61, which is provided for extending the handle 2. The handle module 1000 shown here may be arranged, for example, on the free handle arm 2.1. A further pair of sensor elements 12, 14, for example according to the second exemplary embodiment, may optionally be arranged as a triggering means (not illustrated specifically) on the other handle arm 2.1 and/or at the other bearing point 60.

The movable sensor element 12 is arranged on the printed circuit board 16.1. For example, the movable sensor element 12 may be in the form of a U-shaped sensor sheet. For example, the movable sensor element 12 may be in the form of a spring sheet or spring leaf. The movable sensor element 12 is fastened on the end side in each case to the printed circuit board 16.1 and arranged spaced apart from the fixed sensor element 14 or the printed circuit board 16.1.

The at least one bearing point 600, in particular the handle carrier 4, comprises at least one carry-along element 601. The carry-along element 601 may be in the form of an L-shaped or J-shaped lever. The carry-along element 601 is pivotably mounted for a movement of the handle 2 relative to the handle carrier 4 about a pivot point 602. The carry-along element 601 may be arranged, for example, in the region of a bearing arm 4.1, not illustrated specifically here, of the handle carrier 4. The pivot point 602 may be arranged in the region of the bearing arm 4.1. The carry-along element 601 has a contact surface 601.1, which is operatively connected to the movable sensor element 12. The carry-along element 601 has a stop surface 601.2 which is connected to the contact surface 601.1 and, during a movement of the handle 2 away from the handle carrier 4, comes into contact with a driver 604 arranged on the handle 2. The driver 604 may be formed by the rotary joint 6.2 of the bearing point 600. The stop surface 601.2 may be arranged, in particular held, between the rotary joint 6.2 or the driver 604 and an inside of the handle arm 2.1. The carry-along element 601 is held prestressed in a direction away from the sensor elements 12, 14. A spring force may be applied to the carry-along element 601, for example, by means of a spring element 603, not illustrated specifically, which is arranged on and/or at the pivot point 602. In a retracted handle position 203, not illustrated specifically, and in the unactuated position 200, the carry-along element 601 and the driver 604 may already be in contact. The movable sensor element 12 is prestressed in the unactuated position 200.

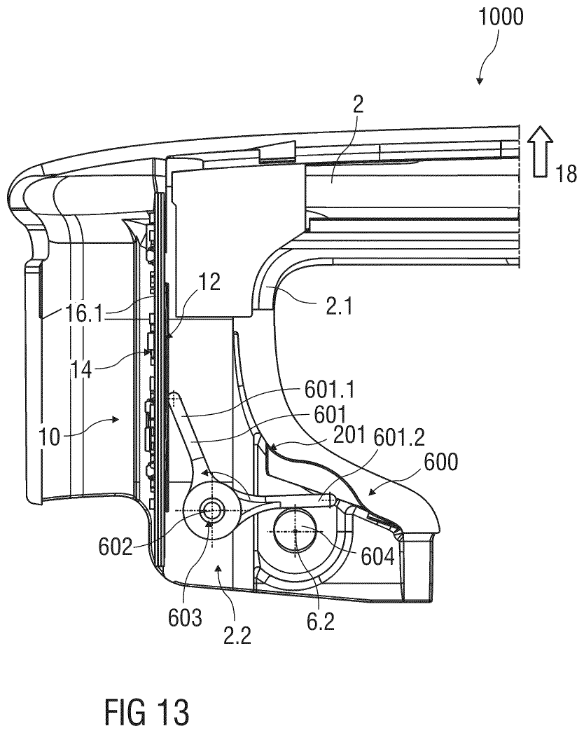

FIG. 13 shows schematically, in a sectional illustration, the sixth exemplary embodiment of the handle module 1000 in an actuated position 201.

In the event of an actuating force 18 acting on the handle 2, a force is applied to the movable sensor element 12 for movement towards the fixed sensor element 14. In this case, the driver 604 moves, in particular presses, the stop surface 601.2 of the carry-along element 601, with the carry-along element 601 being pivoted about the pivot point 602 and the contact surface 601.1 moving towards the movable sensor element 12. In the actuated position 201, the movable sensor element 12 is moved, for example displaced or pressed, by the contact surface 601.1 in the direction of the fixed sensor element 14. By actuation, for example pulling, of the handle 2 away from the handle carrier 4, the movable sensor element 12 is moved in the direction of the fixed sensor element 14 in such a way that a distance and/or an angle between the movable sensor element 12 and the fixed sensor element 14 can decrease. In particular, the distance between the movable sensor element 12, for example a triggering element, and the fixed sensor element 14 is decreased such that a detectable measuring field present between them changes. A movement of the movable sensor element 12 may occur, for example, in a micrometre range.

### LIST OF REFERENCE SIGNS

1, 100, 1000 handle module
2 handle
2.1 handle arm
2.2 handle arm receptacle
4 handle carrier
4.1 bearing arm
6 bearing point
6.1 linear guide
6.2 rotary joint
6.3 pin
8 handle cover
10 sensor unit
12 movable sensor element
14 fixed sensor element
16 electronic unit
16.1 printed circuit board
18 actuating force
20 receptacle
22 carrier receptacle
30 carry-along element
60 bearing point
61 lever mechanism
62 pivot point
63 lever
64 driver
600 bearing point
601 carry-along element
601.1 contact surface
601.2 stop surface
601.3 stop plunger
602 pivot point
603 spring element
604 driver
200 unactuated position
201 actuated position
202 extended handle position
203 retracted handle position
300 extension direction

1-11. (canceled)

12. A handle module, comprising:
a handle,
a handle carrier with at least one bearing point for the movable mounting of the handle relative to the handle carrier and
an electronic sensor unit which has at least one movable sensor element and a fixed sensor element, which is arranged opposite the movable sensor element, wherein the movable sensor element is arranged in the region of the bearing point between handle and handle carrier in such a way that, in the event of an actuating force acting on the handle, the movable sensor element is shiftable or movable relative to the fixed sensor element.

13. The handle module according to claim 12, wherein a distance and/or an angle between the movable sensor element and the fixed sensor element change/changes with a movement of the handle, and therefore a change in the measuring field is identifiable.

14. The handle module according to claim 12, wherein, in an unactuated position, the movable sensor element is held under prestress.

15. The handle module according to claim 12, wherein, in an actuated position, the movable sensor element is relaxable in such a way that it moves away at least in some sections from the fixed sensor element.

16. The handle module according to claim 12, wherein the movable sensor element is in the form of a spring sheet or a spring plate.

17. The handle module according to claim 12, wherein, in an unactuated position, the movable sensor element and the fixed sensor element are aligned parallel to the handle in the region of the bearing point.

18. The handle module according to claim 12, wherein, in an unactuated position, the movable sensor element and the fixed sensor element are aligned perpendicular to the handle in the region of the bearing point.

19. The handle module according to claim 12, wherein at least one bearing point comprises at least one bearing arm which protrudes from a base and on which the handle is held so as to be movably guided, wherein one of the sensor elements is connected to a free end of the bearing arm and another of the sensor elements is connected to the handle, wherein, when the handle is actuated away from the bearing arm, a distance and/or an angle between the sensor elements increases.

20. The handle module according to claim 12, wherein at least one bearing point comprises at least one carry-along element, which is pivotably mounted for a movement of the handle about a pivot point and has a contact surface, which is operatively connected to the movable sensor element and, when the handle is actuated away from the handle carrier, releases the movable sensor element to move away from the fixed sensor element or applies a force to move same towards the fixed sensor element.

21. The handle module according to claim 20, wherein the carry-along element is held under prestress in the direction of the movable sensor element.

22. The handle module according to claim 12, wherein at least one bearing point comprises a lever mechanism with a lever, which is pivotably mounted for a movement of the handle about a pivot point and comprises a driver which, when the handle is actuated away from the handle carrier, carries along the movable sensor element and moves or shifts same away from the fixed sensor element.
